(19) United States
(12) Patent Application Publication
(10) Pub. No.: US 2026/0140250 A1
(43) Pub. Date: May 21, 2026

(54) SPACE OBJECT SEARCHING METHOD AND SYSTEMS

(71) Applicant: InTrack Radar Technologies, Inc., Colorado Springs, CO (US)

(72) Inventor: John Morgan Nicholson, Colorado Springs, CO (US)

(73) Assignee: InTrack Radar Technologies, Inc., Colorado Springs, CO (US)

(21) Appl. No.: 19/389,862

(22) Filed: Nov. 14, 2025

Related U.S. Application Data
(60) Provisional application No. 63/721,010, filed on Nov. 15, 2024.

(51) Int. Cl. G01S 13/72

(52) U.S. Cl. CPC G01S 13/72

(57) ABSTRACT

A method of efficient searching for space objects includes determining a space object to be tracked during a tracking cycle, retrieving location information indicative of a known location of the space object at a previous point in time, generating predicted locations of the space object for at least part of the tracking cycle based on the location information and an amount of time elapsed from the previous point in time, ranking the predicted locations based on utilities associated with the predicted locations, sending, to one or more sensors, a request to track the space object based on the ranked predicted locations, receiving, from each of the one or more sensors, a reply comprising a tracking proposal for tracking the space object during the tracking cycle, evaluating the tracking proposal from each of the one or more sensors, and generating a sensor tasking plan based on the evaluated tracking proposals.

### CROSS-REFERENCE TO RELATED APPLICATIONS

The present application claims the benefit of and priority to U.S. Provisional Application Ser. No. 63/721,010, filed on Nov. 15, 2024, the entire disclosure of which is hereby incorporated herein by reference, in its entirety, for all that it teaches and for all purposes.

### BACKGROUND

Radar technologies may assist numerous industries in carrying out important tasks, such as tracking objects in orbit around Earth.

### BRIEF SUMMARY

Example aspects of the present disclosure include a method, system, and/or device for efficient and effective searching for space objects by determining a space object to be tracked during a tracking cycle; retrieving location information indicative of a known location of the space object at a previous point in time; generating predicted locations of the space object for at least part of the tracking cycle based on the location information and an amount of time elapsed from the previous point in time; ranking the predicted locations based on utilities associated with the predicted locations; sending, to one or more sensors, a request to track the space object based on the ranked predicted locations; receiving, from each of the one or more sensors, a reply comprising a tracking proposal for tracking the space object during the tracking cycle; evaluating the tracking proposal from each of the one or more sensors; and generating a sensor tasking plan based on the evaluated tracking proposals.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a space domain awareness sensor network (SDASN) or system according to at least one embodiment of the present disclosure;

FIG. 2 is a flowchart for operating the system in FIG. 1 according to at least one embodiment of the present disclosure;

FIG. 3 is a flowchart illustrating additional steps for operating the system in FIG. 1 according to at least one embodiment of the present disclosure;

FIG. 4 is a flowchart illustrating additional steps for operating the system in FIG. 1 according to at least one embodiment of the present disclosure;

FIG. 5 is a decision tree for generating a sensor tasking plan according to at least one embodiment of the present disclosure;

FIG. 6A is a block diagram of a radar according to at least one embodiment of the present disclosure;

FIG. 6B is a block diagram illustrating additional details of a radar according to at least one embodiment of the present disclosure;

FIG. 7 is a flowchart for operating a radar according to at least one embodiment of the present disclosure;

FIG. 8 is a flowchart illustrating additional details for operating a radar according to at least one embodiment of the present disclosure;

FIG. 9 is a diagram of an angular search beam pattern for a radar according to at least one embodiment of the present disclosure;

FIG. 10 is a diagram of a stacked beam pattern for a radar according to at least one embodiment of the present disclosure; and

FIG. 11 depicts a flowchart of a method for operating an SDASN, such as that shown in FIG. 1, to search for a lost or new space object according to at least one embodiment of the present disclosure.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device and/or a medical device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia Geforce RTX 2000-series processors, Nvidia Geforce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The sensor scheduling system described herein includes at least the following concepts: implementation of a radar value model to optimize radar collection performance, implementation of an auction for sensors to propose their collection, a decision-theoretic approach to determination which sensor receives a particular tasking, a machine learning implementation of determining probability of success and covariance reduction, and development of mission performance metrics to prioritize future financial investments and sensor upgrade priorities.

This combination of features provides a highly flexible, adaptive, and optimal scheduler to improve performance of each sensor at the system level as well as a network of cooperative sensors. Additionally, the systems and methods describe herein aim to track many objects in space to protect humans and avoid satellites hitting each other.

As described herein, a command and control (C2) node maintains a space catalog which may contain data about known satellites or other outer space objects. The catalog may include data relating to Orbital Element Sets (ELSETs) for each space object, which may include state vectors (e.g., 6 or 9-term vectors related to position, velocity, and acceleration in a coordinate system). State vectors of a space object may inform on the object's location and movement in outer space and may be propagated over time to predict the locations and paths of objects and satellites.

State vectors can become stale after a period of time, such as couple of days, and need to be refreshed. Sensors capable of tracking the space objects are “tasked” with this collecting data used to refresh the state vectors for space objects.

To explain the problem and solution by way of an example, there may be 20,000 trackable space objects and fifteen deep space sensors with different constraints and in different locations around the world. These constraints make it difficult to determine how each sensor schedules its resources to track a given set of space objects. Example embodiments propose to solve these and other problems in the art via a C2 node that queries sensors for a subset of the space objects, searches for which sensors are available for tracking the space objects, and then selects the best sensor (which may be a function of a believability metric carried by the C2 node because in some cases, sensors can be inaccurate.) The C2 node may then auction off space objects to the sensors for tracking while also being able to provide information about the sensors themselves, such as whether the sensor needs to change location, needs maintenance, needs an upgrade, and the like.

The C2 node, then, is said to optimize the time for collecting observation data used to track space objects with the help of a value model specifically developed for deep space sensors. The concept of Value Driven Design (VDD) proposes the application of microeconomics to guide performance requirement allocation in Systems Engineering Design. The core idea of VDD involves the development of a value model, which is an objective function, to guide design decisions rather than requirements allocation. Linearization of this value model may allow distributed optimization to lower-level components of the system to optimize independently. To be effective, the linearization must be performed near a local optimum, ideally near the global optimum.

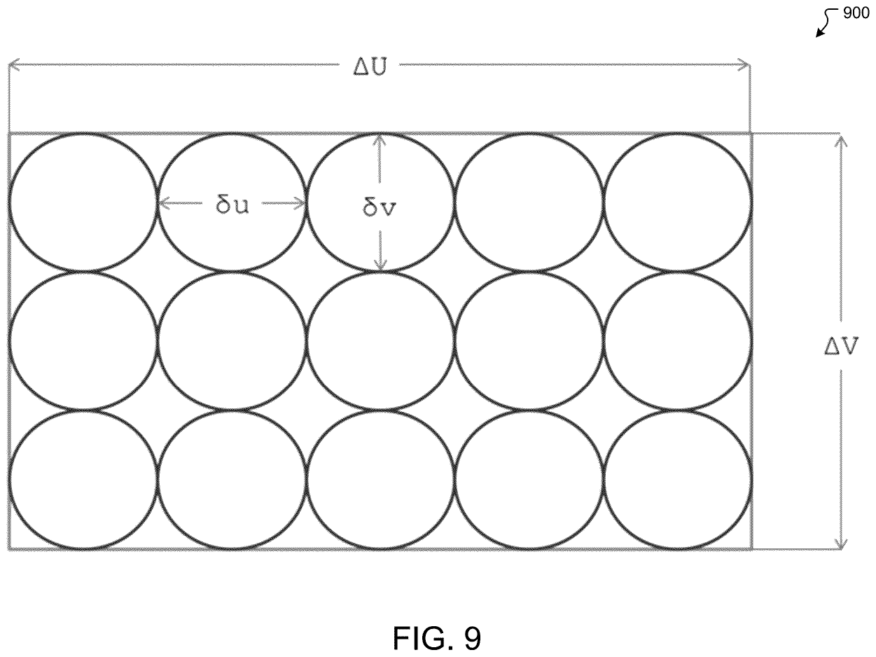

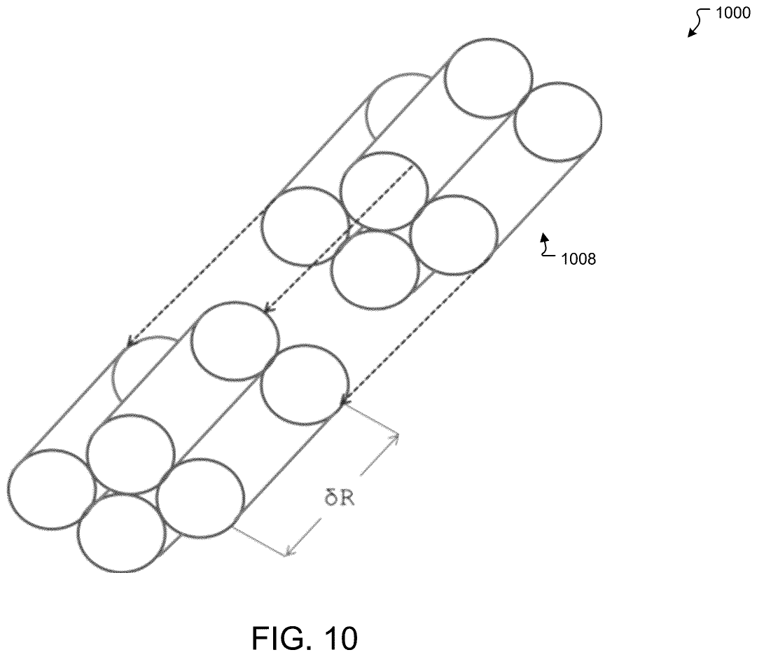

The present disclosure makes use of a value model developed for Space Domain Awareness (SDA) radar, where individual radars (or other suitable deep space sensors) use a common value model to arrive at their tracking proposals for sending to the C2 node. This value model is described in more detail with reference to FIGS. 9 and 10 of the present disclosure but is repeated for reference in the equation below and may guide engineering design activities and/or optimize radar performance during initial system alignment.

$$\begin{matrix}{t}_{collection} = \frac{\{ {e}_{volume} \cdot ⌈ \frac{Δ R}{δ R} ⌉ \cdot ( ⌈ \frac{Δ u}{δ U} ⌉ ⌈ \frac{Δ v}{δ V} ⌉ ) \} \{ ⌈ \frac{SNR \cdot {L}_{Scan} \cdot {R}^{4}}{σ \cdot ψ} ⌉ \cdot PRI + {t}_{Process} \}}{{P}_{searchDetection} {P}_{confirmationDetection}} \\ + ( 1 + {P}_{searchFA} E [ {n}_{SearchScans} ] {n}_{SerchDwells} ) \{ ⌈ \frac{SNR \cdot {L}_{Scan} \cdot {R}^{4}}{σ \cdot ψ} ⌉ \cdot PRI + {t}_{Process} \} \\ + {n}_{obs} ⌈ \frac{{σ}_{Dwell}^{2}}{{σ}_{Ob}^{2}} ⌉ \cdot \{ ⌈ \frac{SNR \cdot {L}_{Scan} \cdot {R}^{4}}{σ \cdot ψ} ⌉ \cdot PRI + {t}_{Process} \}\end{matrix}$$

As noted in more detail below, antenna slew time could be added to accommodate a dish radar while an optical sensor or passive RF sensor could implement a value model in the same fashion to coordinate between optical sensors and radar sensors.

The SDA Network level architecture proposed herein can apply the above value model or similarly computed value model to mission planning at the network level as well as at the sensor level. For individual sensor planning, each sensor can manipulate the value model parameters to optimize the efficiency of the data collection on a Resident Space Object (RSO) (more generally called a “space object” herein). Each sensor may then provide the results of the value module computation to the C2 node, such as in the form of a tracking proposal, which the C2 node may use for tasking sensors to track space objects.

Embodiments of the present disclosure provide technical solutions to one or more of the problems of (1) inefficiency in modern technologies for tracking cataloged space objects, and (2) tracking objects not currently catalogued.

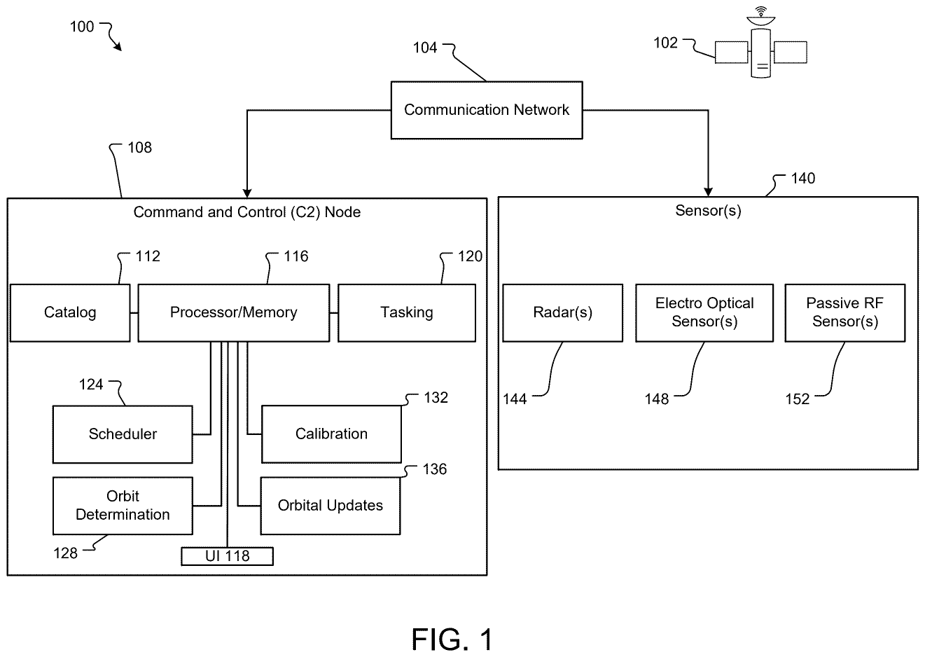

Turning now to the figures, FIG. 1 illustrates a block diagram for system 100, such as an SDASN, according to at least one embodiment of the present disclosure. The system 100 may be used to detect, identify, and catalog space objects 102 in orbit around Earth, where such space objects correspond to space debris, satellites, or other objects of interest in space. The system 100 comprises a communication network 104 that enables wired and/or wireless communication between a command and control node (C2 node) 108 and one or more sensors 140. The C2 node 108 may include or be in communication with a catalog 112, which may correspond to a stored listing of known space objects and their most recent state vectors (or even full ELSETs). The C2 node 108 may further include a processor and memory 116 for controlling computing tasks (e.g., by the processor executing instructions stored on the memory), a user interface 118 for providing user readable input/output capabilities (e . . . , a display, mouse, keyboard, etc.), a tasking module 120 for scheduling sensors 140 to track space objects with observations during a tracking cycle (also called a planning cycle), a scheduler 124 for scheduling operations within the SDASN network, an orbit determination module 128 for determining orbits of space objects and storing information about the orbits (e.g., in ELSETs), a calibration module 132 for aligning observation data from sensors 140, and an orbital update module 136 for updating state vectors of space objects. Here, it should be appreciated that the processor/memory 116 may also correspond to or include any suitable hardware and software for carrying out computing tasks, which may include implementations as a central processing unit (CPU), a graphics processing unit (GPU), a field programmable gate array (FPGA), a system on chip (SoC), an integrated circuit (IC), an application specific integrated circuit (ASIC), and/or other collection of logic circuits. Thus, non-limiting examples of a C2 node 108 include a personal computer, a server, a cloud-hosted application residing on a server and accessible by users, and/or the like.

As shown, the sensor(s) 140 may comprise one or more sensors for tracking objects in space, such as one or more radars 144, one or more electro optical sensors 148, and/or one or more passive RF sensors 152. As may be appreciated, the sensors 140 are spread throughout world and contain technology for tracking space objects (e.g., with X-band signals if radar or other suitable signals). As used herein, state vectors for space objects may comprise a set of variables that define the space object's location within space, which may include position and velocity information at a point in time within a coordinate system (e.g., an orbital coordinate system).

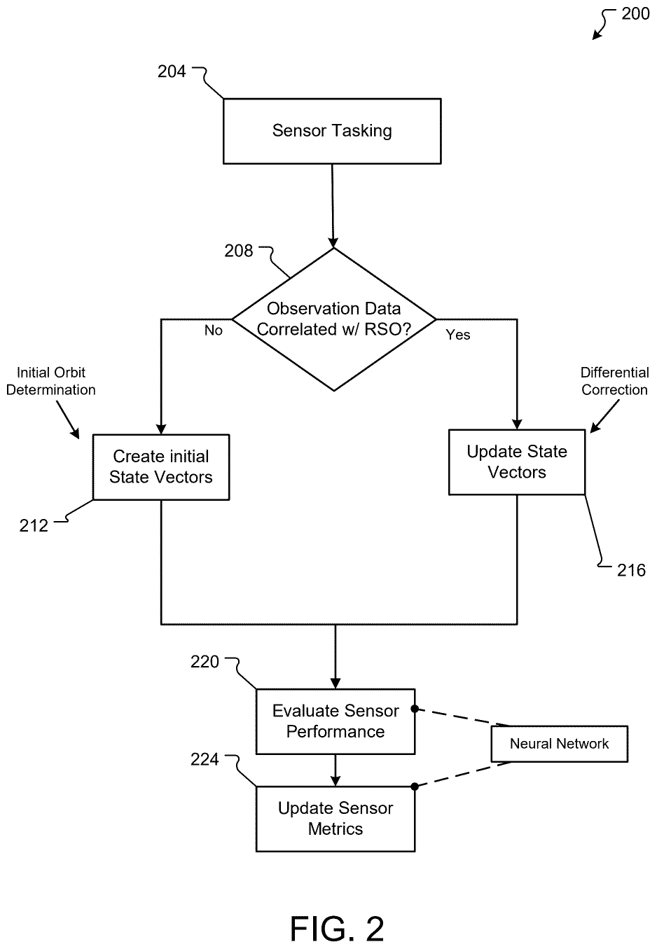

FIG. 2 depicts a flowchart of a method 200 for operating an SDASN, such as that shown in FIG. 1. The method 200 may be performed by C2 node 108 as part of a process to catalog new space objects by creating initial state vectors (and corresponding ELSETs) and/or to maintain previously cataloged space objects by updating state vectors (and corresponding ELSETs). At a high level, the method 200 involves determining which space objects from the catalog 112 have state vectors (or ELSETs) that are outdated, and thus, due for a refresh, tasking sensors 140 to collect observation data for at least some of the space objects in need of refresh and/or for a new space object, creating or updating state vectors based on observation data from sensors 140, evaluating performance of the sensors 140 (e.g., evaluating the accuracy of the observation data), and then developing or updating metrics pertaining to sensor performance, such as believability and/or accuracy metrics, to assist with future tasking decisions. As may be appreciated, performing method 200 in accordance with example embodiments provides flexible and adaptive, and in many cases, optimal scheduling of sensors 140 for tracking space objects while simultaneously providing feedback to improve sensor performance, and thus improve efficiency of the overall sensor network.

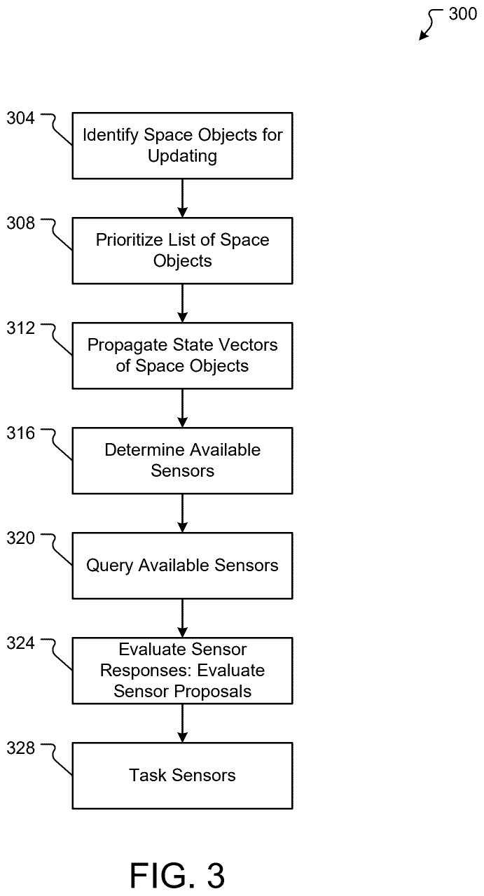

The method 200 begins by tasking sensors 140 to collect observation data for a space object in step 204. Tasking sensors 140 may comprise a number of sub-steps for instructing sensors 140 to obtain observation data for a particular RSO or group of RSOs. These sub-steps generally involve identifying uncatalogued RSOs and/or cataloged RSOs whose location data (e.g., state vectors, ELSETs, etc.) is outdated or considered “stale,” and then determining which sensors 140 are best for obtaining observation data used to create or update the space object location data. The determination of which sensor(s) 140 are best suited for obtaining observation data of a particular space object may be based on a value model computed at each sensor 140 and used by the sensor 140 to provide a tracking proposal the C2 node for tracking the space object. Thereafter and based on the tracking proposals, the C2 node assigns or “tasks” the sensors 140 to track a particular RSO or set of RSOs, which may include each sensor 140 generating the aforementioned observation data. These and other sub-steps of step 204 are described in more detail below with reference to FIGS. 3-5.

Then, in step 208, the method 200 may proceed to aggregate the observation data generated in step 204 and attempt to correlate the observation data with space objects in the catalog 112. The correlation attempt in step 208 may be carried out using a suitable algorithm for determining whether a set of observation data from a sensor 140 or set of sensors 140 matches a particular space object in the catalog 112, and if not, that particular space object is considered as a new space object for the catalog 112 and method proceeds to step 212 to create initial state vectors for the new space object. Attempting to match observation data with space objects may include comparing identifying information of space objects in the catalog 112 to corresponding identifying information in the observation data. Such identifying information may correspond to the size of a space object (e.g., one or more dimensions), shape of a space object, electromagnetic signature of a space object, state vectors of a space object, state covariance of a space object, and/or other visual or nonvisual characteristics of a space object.

If step 208 is able to correlate the set of observation data with a particular space object, then the method 200 proceeds to step 216 to update the state vectors of the particular space object. Updating the state vectors in step 216 may comprise performing a differential correction of the existing state vectors to generate updated element sets. The updated state vectors may replace the old state vectors in the catalog 112 or be appended to the old state vectors so as to enabling tracking of the location history of the space object.

The method 200 may proceed to step 220 which includes evaluating performance of the sensors 140 which provided the observation data in step 204. Sensor performance metrics can be collected and refined based on the results of each sensor's 140 tasking and used to help increase or maximize sensor performance. Performance metrics may include a believability metric, a tasking response metric, and/or an accuracy metric, some or all of which may be used to assess the value of each sensor's 140 contribution the network the help guide decisions on how to allocate financial resources to sensor maintenance, sensor upgrades, and sensor operations in the future.

In some examples, step 220 includes the C2 node 108 inputting some or all of the observation data into a machine learning algorithm, such as a neural network trained with data that enables evaluation of the performance metrics of a particular sensor or set of sensors 140. The output of the machine learning algorithm may include information that enables the C2 node 108 to update one or more sensor performance metrics related to believability and/or accuracy of a sensor 140 in step 224.

In particular, the C2 node may use a machine learning algorithm to evaluate sensor performance related to believability and, if needed, update the believability metric for a sensor 140 that describes the believability of the sensor's 140 tracking proposal for a particular space object or group of space objects. For example, a sensor 140 may over estimate or under estimate its own capabilities when computing its corresponding value model, which results in providing a tracking proposal to the C2 node that does not fully reflect the sensor's actual capabilities and can lead to fewer successful tracking attempts if sensor capabilities are overstated and/or less efficient tracking if sensor capabilities are understated. Thus, the believability metric may reflect how believable the tracking proposal is for a particular sensor 140 and may correspond to or be computed as a probability of how likely or not likely the sensor 140 is to successfully track an space object or group of space objects in accordance with the tracking proposal (e.g., within the amount of time estimated by the value model).

Additionally or alternatively, the C2 node 108 may use a machine learning algorithm to evaluate sensor performance related to accuracy and, if needed, update the accuracy metric for each sensor 140 that reflects the accuracy of the observation data collected by the sensor 140. A sensor 140 may be known or suspected to provide inaccurate pieces of observation data due to inherent or extrinsic properties of the sensor 140. The accuracy metric, then, assists the C2 node 108 with accounting for these inaccuracies of sensors 140 during sensor tasking. The accuracy metric may take the form of a standard deviation. For example, a piece of observation data from one sensor 140 is too far from the standard deviation for that piece of observation data, then the sensor's accuracy metric may be lower. In some cases, the accuracy metric is incorporated into or already reflected by the believability metric since less accurate sensors are generally less believable while more accurate sensors are generally more believable. This believability metric will be refined over time using machine learning by comparing the sensor tracking proposal to sensor performance. Additionally, tracking calibration satellites can inform the believability metric by providing highly accurate truth data to the C2 node 108 for comparison.

The present disclosure encompasses embodiments of the method 200 that comprise more or fewer steps than those described above, and/or one or more steps that are different than the steps described above.

FIG. 3 illustrating additional steps for operating the system in FIG. 1 according to at least one embodiment of the present disclosure. In particular, FIG. 3 depicts a method 300 that further describes the tasking step 204 from FIG. 2. Performing sensor tasking according to the present disclosure may conserve network and/or processing resources normally required by related art tasking systems.

The method 300 begins with step 304 by identifying or selecting, from among a plurality of space objects, one or more space objects to be tracked during a tracking cycle. A tracking or planning cycle may be defined as a period of time during which one or more of the sensors 140 are tasked with attempting to track space objects. A tracking cycle may have a specified duration, such as 24 hours, during which space objects selected in step 304 are attempted to be tracked by sensors 140. Selected space objects may have one or more recorded data points that are in need of updating compared to unselected space objects. Regarding possible data points in need of an update, the selected space objects may have state vectors or ELSETs that are in need of updating or that should be updated. For example, step 304 may involve checking the catalog 112 and selecting space objects in the catalog 112 that have state vectors or ELSETs that are out of date (e.g., it has been longer than a threshold amount of time since a previous update, such as two days, three days, etc.). In some examples, a space object is selected or identified in step 304 because that space object is of particular interest (e.g., space debris threatening a satellite, a satellite belonging to an adversary, etc.). Selection of space objects in step 304 may be performed automatically and/or based on user input to a UI 118 of a C2 node 108. In some examples, step 304 identifies and selects a new space object not yet in the catalog 112 but known or suspected to exist within a field of view of one or more of the sensors 140 during the tracking cycle.

The method 300 may proceed by prioritizing the list of space objects selected in step 304 (Step 308). For example, the C2 node 108 may rank the one or more space objects selected in step 304 based on at least one parameter associated with the one or more space objects. At least one parameter may describe or relate to an aspect of a space object that the C2 node 108 or its controlling entity see as relevant to how and when to that space object is scheduled to be tracked relative to other selected space objects. Possible parameters of a space object taken into account for ranking include size of the space object, proximity of the space object to an asset of interest, threat potential of the space object (the space object is generally threatening, such as an adversarial or high priority satellite, or a threat to damage another space object), last known maneuver of the space object (e.g., an unusual maneuver may receive higher priority), last recorded state vectors of the space object, or any combination thereof. Step 308 may produce a list having each space object placed into one of a number of categories (e.g., five categories) arranged from highest priority to lowest priority.

The method 300 may include propagating state vectors for each of the one or more space objects in the prioritized list of space objects over a duration of the tracking cycle (e.g., over an entire duration of the tracking cycle) (Step 312). Propagating state vectors may be performed in accordance with any suitable technique but should be generally understood to involve predicting future state vectors of a space object using historical state vectors of the space object, such as already recorded state vectors in catalog 112, along with any other available information related to predicting a path of the space object. Stated another way, step 312 involves predicting paths (e.g., orbital paths) of the space objects selected and prioritized in steps 304 and 308 over the duration of the tracking cycle.

With knowledge of the predicted paths (or the predicted state vectors) of the space objects, the method proceeds to step 316 to determine, from a plurality of sensors 140, one or more sensors 140 capable of tracking the one or more space objects based on the propagated state vectors. For example, the propagated state vectors or the predicted paths of the space objects are used to determine which sensors 140 have a field of view that overlaps with at least part of the predicted paths of the space objects during the tracking cycle, with step 316 considering those sensors as candidates for tracking the space objects. Stated another way, for a particular space object, the C2 node 108 may determine which sensors 140 have a field of view that overlaps with the space object's predicted path and determines those sensors as being available to track that space object. At this stage, the method 300 has produced a prioritized list of space objects to be tracked as well as a list of candidate sensors 140 that may be used to track those space objects.

Step 320 includes querying the candidate sensors from step 316 to obtain a response from each sensor 140 that is indicative of whether that sensor 140 can successfully track one or more space objects within the prioritized list of space objects. For example, step 320 includes the C2 node 108 sending, to each of the sensors 140 identified in step 316, a request to track the one or more space objects. The request for each sensor 140 may include a list of space objects that fall within the field of view of that sensor 140 during the tracking cycle and each space object's propagated state vectors. Notably, the list of space objects sent to a sensor 140 in step 320 may be a subset of the larger list of space objects from step 308, and a subset of space objects sent one sensor 140 may at least partially overlap with space objects that are also included a subset of space objects sent to another sensor 140 (zero overlap between subsets of space objects sent to different sensors is also possible).

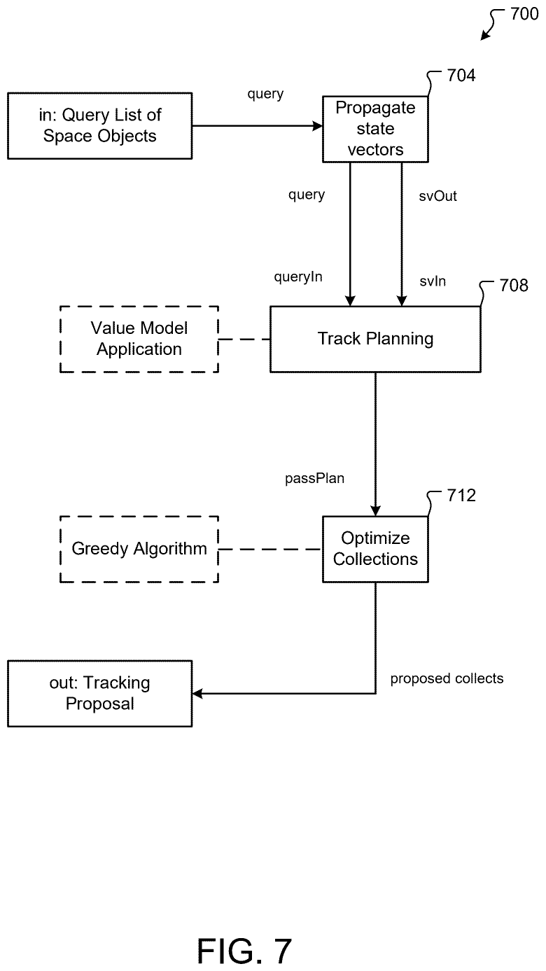

As described in more detail below with reference to FIGS. 7-10, each available sensor 140 may receive a corresponding list of space objects and associated propagated state vectors from the C2 node in step 320 and generate a response indicative of the sensor's 140 ability to track each space object on the list. In particular, as described with reference to FIGS. 7-10, each sensor 140 may use the value model described herein to estimate an amount of time t_{collection} required to successfully track each space object and generating a tracking proposal based on the value model. Each sensor 140 may then send its tracking proposal back to the C2 node to enable the method 300 to move forward.

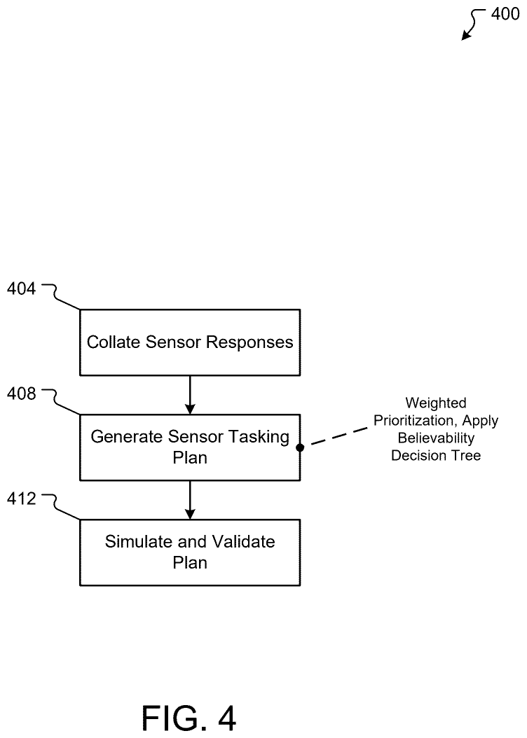

Returning to FIG. 3, step 324 may include receiving and evaluating sensor responses to the query in step 320. For example, step 324 may include the C2 node 108 receiving, from each of the one or more sensors 140 queried in step 320, a reply comprising a tracking proposal for tracking the one or more space objects over the tracking cycle, and then evaluating the tracking proposal from each of the one or more sensors 140. The C2 node 108 may evaluate the tracking proposal from each sensor 140 based on one or more sensor performance metrics for each sensor 140 and use the evaluation to generate a corresponding sensor tasking plan that indicates which sensors 140 will be assigned to track which space objects. FIG. 4 describes the evaluation step 324 in additional detail.

The method 300 may then proceed to step 328 to task or assign sensors 140 to track the space objects in accordance with the sensor tasking plan from step 324. For example, the C2 node 108 sends commands, in accordance with the sensor tasking plan, to each sensor 140 to cause that sensor 140 track each space object on the sensor's assigned list of space objects during assigned time windows throughout the tracking cycle. Each sensor 140 may generate observation data which is handled in the same or similar manner as described above with reference to FIG. 2.

FIG. 4 illustrates a method 400 for operating the system in FIG. 1 according to at least one embodiment. As noted above for the method 300, each sensor will provide a proposed data collection in the form of a tracking proposal along with a performance metric for the data collection. The sensor 140 is enabled to self-optimize using the value model, estimate the performance of that collection, and provide that estimate to the C2 node 108. Specifically, FIG. 4 illustrates details for evaluating sensor tracking proposals in step 328 from FIG. 3 to generate a sensor tasking plan. As described in more detail below, the C2 node 108 may collect and combine the sensor responses into a single data collection plan that can be pruned to meet the requirements for the tracking cycle. This pruning is performed to optimize sensor network performance, which may include minimizing the collection times, therefore maximizing throughput. Finally, the sensor tasking plan may be simulated to validate plan feasibility.

Step 404 includes collating sensor responses which were prompted by the requests in step 320. Step 404 may include organizing the sensor responses in a format that is suitable for computational digestion. For example, the tracking proposals from each sensor 140 are grouped together. In another example, the tracking proposals for individual space objects are grouped together. However, embodiments are not limited thereto, and the sensor response may be organized in any suitable fashion.

Step 408 includes generating a sensor tasking plan based on the collated sensor responses. The sensor tasking plan may initially be generated to match or align with the sensors' tracking proposals but the sensor tasking plan may then be adjusted based on the same sensor performance metrics as those described above with reference to steps 220 and 224. For example, each sensor 140 may have an associated believability metric, accuracy metric, or both, which is maintained and updated at the C2 node. The C2 node may use these performance metrics to aid with determining whether the tracking proposals from the sensors 140 are reliable and will result in the predicted outcome (e.g., by successfully tracking a space object within the amount of time computed by the value model). If the performance metrics indicate that a given sensor 140 is less or more believable and/or accurate for a given space object, then the C2 node may adjust or generate the sensor tasking plan to account for the performance metrics. Adjusting the sensor tasking plan may include consulting the ranking from step 308 and tasking more reliable sensors 140 with higher ranked space objects and/or tasking less reliable sensors 140 with lower ranked space objects. Other sensor tasking plan adjustments are possible but not listed here for the sake of brevity.

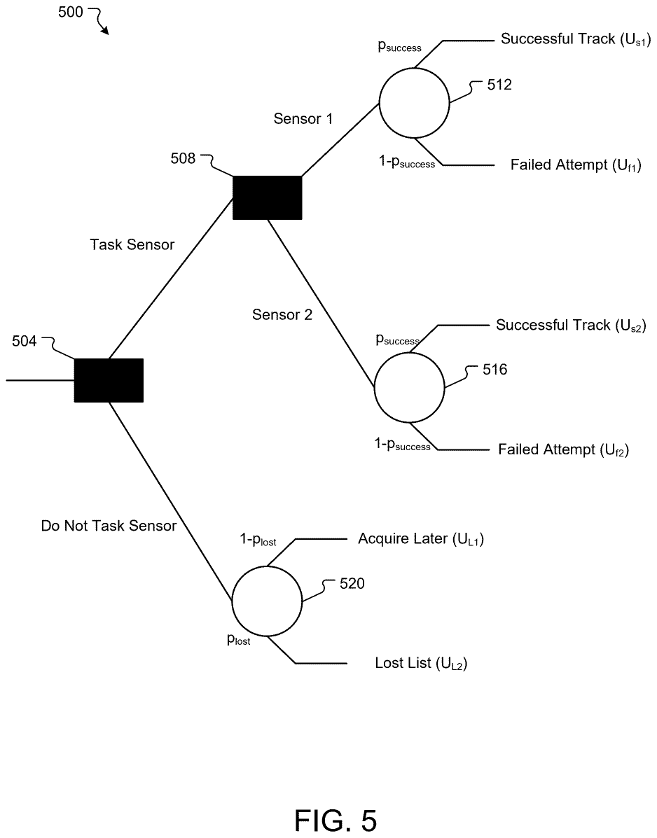

In some examples, step 408 includes applying a decision tree that accounts for each sensor's probability of successfully tracking the one or more space objects. FIG. 5 illustrates an example of decision tree a decision tree 500 that may be used by the C2 node 108 to generate a sensor tasking plan. As may be appreciated, the decision tree is a decision-theoretic approach for sensor tasking and may take into account probabilities of successfully tracking space objects and the earlier-mentioned ranking of space objects. In more detail, FIG. 5 depicts the decision tree 500 for a space object capable of being tracked by two sensors, Sensor 1 and Sensor 2. In some examples, the tree 500 is used to assign a network utility or value to each sensor's possible collection of observation data for a particular space object. The boxes 504 and 508 are decision nodes while circles 512, 516, and 520 are chance nodes with paths that each have an associated probability of successfully tracking the space object (denoted with p_{success} which may correspond to or be related to the believability metric described herein) and a weight indicative of the space object's ranking from step 308, which may be a measure of how important it is to successfully track that space object (denoted with Uₓₓ). In some examples, the probability in each branch is multiplied by the weight of that branch with the result being used to determine which sensor 140 should be tasked with tracking the space object. As noted above in steps 220 and 224 of FIG. 2, the probabilities and importance weights in the decision tree 500 may be improved over time through machine learning.

The method 400 may optionally include a step 412 of simulating at least part of the sensor tasking plan and then validating or invalidating the sensor tasking plan based on the simulation. For example, the C2 node 108 may run a suitable algorithm that simulates collection of observation data in accordance with the sensor tasking plan and determine whether the simulation produces an acceptable result. If the sensor tasking plan is validated, then the C2 node tasks the sensors according to the sensor tasking plan. If the sensor tasking plan is invalidated, then the C2 node may reevaluate the tracking proposals and generate an updated sensor tasking plan for re-simulation.

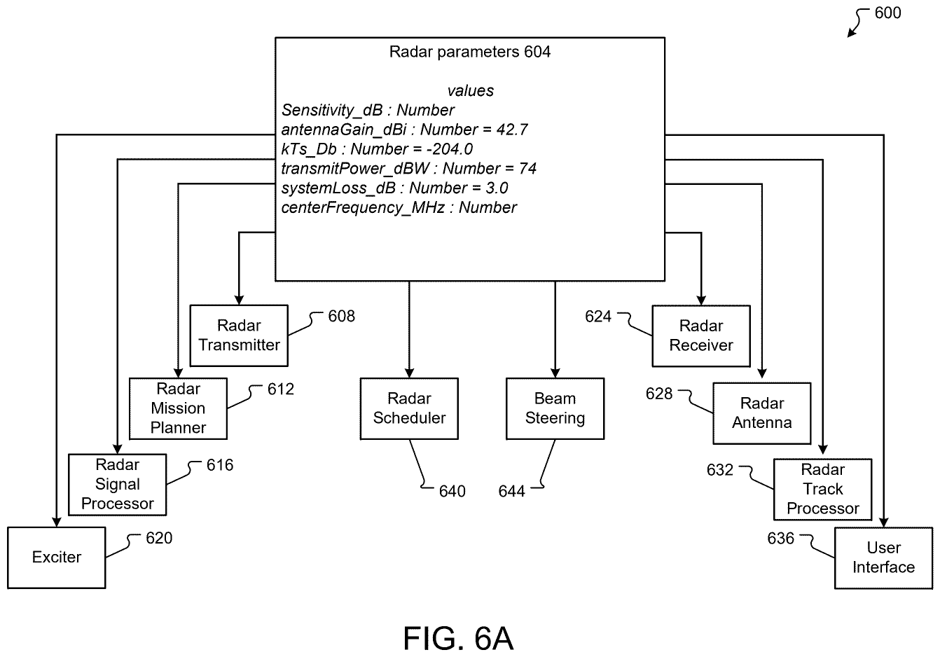

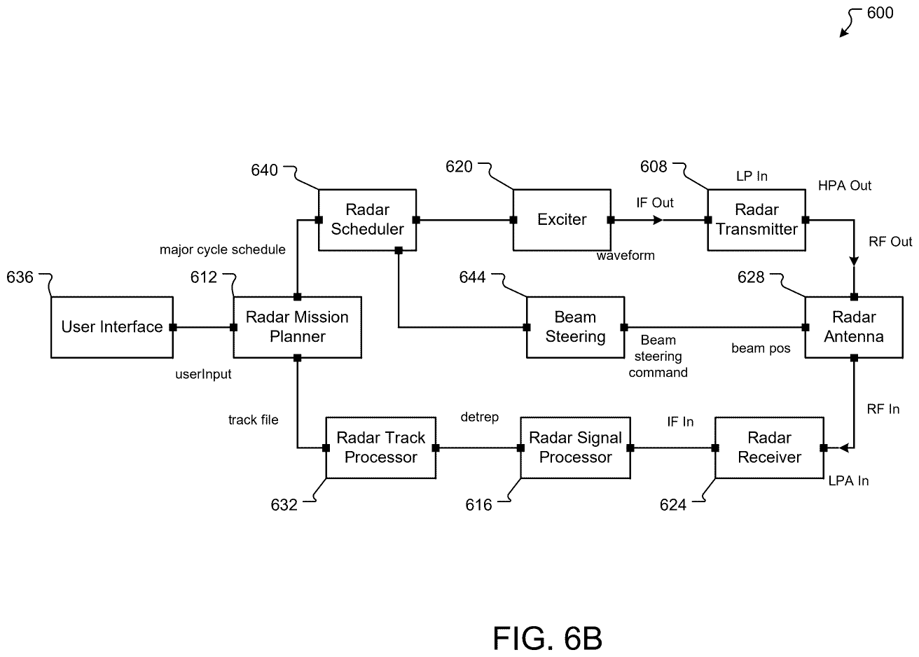

FIG. 6A depicts a block diagram of an exemplary radar 600 according to at least one embodiment of the present disclosure. The radar 600 may correspond to an example of a sensor 140 described herein. The radar 600 may be used to provide a track proposal for each space object in a query based on the value model described herein. As shown, the system 600 comprises radar parameters 604, a radar transmitter 608, a radar mission planner 612, a radar signal processor 616, an exciter 620, a radar receiver 624, a radar antenna 628, a radar track processor 632, a user interface 636, a radar scheduler 640, and beam steering 644.

Radar 600 may be any suitable radar for tracking objects in space (e.g., phased-array radars, parabolic radars, etc.). The radar transmitter 608 may be any suitable transmitter commonly found in radars for tracking space objects and may include circuitry to generate electromagnetic pulses to find targets. The radar mission planner 612 may be a module that helps plan and prepare the radar 600 for tasks such as providing tracking proposals for each space object in a query. The radar signal processor 616 can process the received reflected signals from the space objects. The exciter 620 can impact range, accuracy, and ability to detect targets by, for example, generating timing signals and frequency signals to synchronize a transmitter and receiver. The receiver 624 may process signals reflected from a space object which correspond to signals initially transmitted by the transmitter 608. The radar antenna 628 can function as the physical interface for both transmitting signals from the transmitter 608 and receiving signals for the receiver 624. The radar antenna 628 may be suitable for space radar applications and may include or correspond to a phased array antenna, a parabolic “dish” antenna, a slotted planar array antenna, a horn antenna, etc. The radar track processor 632 may identify, track, and predict movement of space objects. The user interface 636 may include the same or similar features as the UI 118 in FIG. 1. The radar scheduler 640 may aid in allocating tasks for the radar 600. The radar beam steering system 644 may adjust and direct a transmitted beam without physically moving the radar antenna 628. FIG. 6B illustrates how the various elements of the radar 600 are used in operation.

FIG. 7 depicts a flowchart of a method 700 that may be used by a sensor 140, such as a radar 600, to handle the query and generate the response described with reference to steps 320 and 324 in FIG. 3, for example. In more detail, the method 700 computes a metric according to the value model for each queried space object in priority order (i.e., based on the ranking in step 308).

Step 704 includes receiving a list of space objects and associated propagated state vectors by way of the query in step 320 and, and if needed, propagates state vectors for the list of space objects to arrive at predicted paths for the space objects. In some cases, as described above, the C2 node 108 has already propagated the state vectors for the space objects and predicted paths of the space objects and so step 704 may be skipped or have reduced computation time. However, in other cases, propagating the state vectors to predict a path of each space object is first (or again) carried out at the sensor 140 in step 704. For example, propagating the state vectors at the sensor 140, whether for the first time or as a repeat step, may be performed if the C2 node 108 is not fully aware of the sensor's 140 capabilities and/or positioning, and thus, cannot confidently predict whether the sensor 140 will be a candidate to track a space object. In another example, the C2 node 108 may propagate a subset of state vectors for a particular space object and leave determination of the remaining state vectors to step 704. In any event, the list of space objects and information about the state vectors (sv) serve as inputs to a track planning step 708.

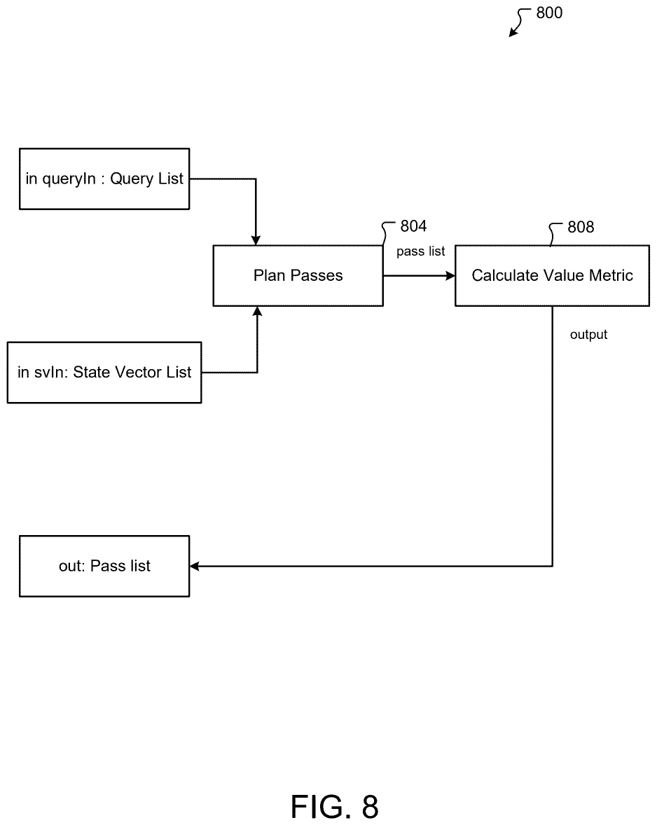

Step 708 includes receiving the query and state vectors from step 704 and applying the value model from equation 24 described below with reference to FIGS. 9 and 10. Step 708 corresponds to the sensor's self-optimization process which may include adjusting variables in the value model to optimize collection of observation data for a space object. Stated another way, the value model enables the sensor to decide which space objects to track in a manner that accomplishes as much as possible within a tracking cycle. Step 708 is described in more detail with reference to FIG. 8, which illustrates a method 800 that includes a step 804 for determining which space objects in the list received by the sensor 140 are actually able to be tracked by the sensor 140 to arrive at a pass list. Step 804 may exclude space objects from the pass list which are predicted, by way of the propagated state vectors, to not fall within the sensor's 140 field of view for enough time to perform the three stages of tracking. Thereafter, step 808 calculates a value metric (e.g., t_{collection}) for each space object on the pass list according to the value model. Output from step 808 may include the pass list of space objects which can be tracked by the sensor 140 and their corresponding value metrics. This pass list of space objects and value metrics may serve as input to step 712 to optimize collection of observation data. Step 712 may include applying a greedy algorithm to the pass list based on priority of the space objects and/or scheduling capacity of the sensor 140. This ensures that higher priority space objects are part of the sensor's 140 tracking proposal sent back to the C2 node 108 and/or that the sensor 140 does not waste time or resources during the tracking cycle. Thus, it should be appreciated that indication of the ranking in step 308 may be part of the input in step 704.

The above-mentioned value model for system level design of large scale, ground based, Deep Space Surveillance radar systems will now be discussed in detail. The value metric is the time required to perform a satellite track called the collection time. The collection time is the sum of the time required to acquire a signal, confirm that the signal is likely a target and track the target by making however many observations requested. The Value Model is then used to perform system analysis on a notional space surveillance radar system. Having a value model for the total time a radar needs to gather all the information on a satellite for JSPOC, allows for quick and accurate trade studies and optimization while designing or modernizing a radar.

Large ground based, phased array radars are highly complex systems with several competing performance parameters. Multipulse processing radars for Deep Space surveillance are a subset of this class of radar system. Modifications that occur on Deep Space surveillance radars are often performed using a set or requirements, that is, a point estimate of the combination of design parameters that define the system performance, but this technique of requirements engineering frequently leads to suboptimal design. An alternative approach, which is used in the present disclosure, is to create a value model for the radar system that can be provided in place of requirements.

The disclosed value model facilitates the direct comparison of alternative design concepts or implementations by deriving the relationship between the radar performance measures in a single metric. The creation of this single metric, where smaller values are preferred, creates an objection function that can be evaluated to perform trade studies and design activities. Either traditional optimization techniques can be applied, or the model can be linearized and distributed. The value model will now be described in more detail below.

Deep Space (DS) surveillance radars, which may be included in sensors 140, detect, track, and identify Earth orbiting space objects, such as satellites and debris in the DS orbital regime. The DS orbital regime is defined as having an orbital period greater than 225 minutes. In some examples, DS surveillance radars support the Space Surveillance Network (SSN) by collecting smoothed radar measurements of the satellite or space object, called Observations (Obs), and sends those smoothed measurements to the Joint Space Operations Center (JSpOC), which may include or correspond to a C2 node 108. The JSpOC uses radar Obs to update the Orbital Element Set (ELSET) (e.g., used to update state vectors in the ELSET) that can predict the location of the satellite at a time in the future. This prediction information is used to perform assessments such as conjunction analysis.

Since Obs are the primary data product produced by DS surveillance radars, a more efficient and effective radar can produce more Obs of a given quality in a given time. Observation quality is typically associated with measurement precision. Other factors that impact the time required to collect observation data are availability, radar sensitivity, search volume and data processing time. The metric used for the DS surveillance radar value model is shown in Equation (1).

$$Value = \frac{t}{O} \qquad ( 1 )$$

$$Where for Equation ( 1 )$$

$$\begin{matrix}O = Number of Radar Observations \\ t = time in seconds\end{matrix}$$

Several key radar parameters impact the Time Between Obs metric that will be discussed, analyzed and added to the value model in the following sections.

Many radars, including DS surveillance radars, follow a three-step radar track sequence of operational modes to track a space object during a tracking cycle. This sequence is to perform Search, Verification and Track modes. That is, the radar begins by entering Search mode where the radar generates large search volumes using course radar waveforms and searches for the target (i.e., a space object) using a raster, bowtie, spiral or some other type of scan. Once a search dwell warning indicates a target is detected (which may occur when the radar's beam is fixed on a target for some minimum amount of time), the radar switches to a verification mode and follows up on the search dwell warning with a confirmation dwell warning, which indicates a low Probability of False Alarm (Type I error). If the detection processing on the confirmation dwell indicates a target is present, then the target is considered verified, and the radar will initiate a track sequence. The track sequence involves collecting a sequence of measurements on the target and predicting the target's state vector(s) using a track filter. The sequence of measurements is smoothed to generate Obs which are sent to the C2 node. In some examples, the radar collects three Obs for each successful satellite track.

The time to collect Obs is the sum of the time required to perform each of the three radar modes in the sequence. Therefore, for a successful collection, three observations are generated. This is shown in Equation (2).

$${t}_{collection} = {t}_{acquisition} + {t}_{verification} + {t}_{track} \qquad ( 2 )$$

$$Where for Equation ( 2 )$$

$$\begin{matrix}{t}_{collection} = total data collection time for DS ( sec ) \\ {t}_{acquisition} = time required for target search function ( sec ) \\ {t}_{verification} = time required for target verification ( sec ) \\ {t}_{track} = time required for target track function ( sec )\end{matrix}$$

Next, a Radar Range Equation (RRE) can be used to calculate the expected Signal-to-Noise Ratio (SNR) as a function of the parameters of the radar and the characteristics of the target. The SNR is the ratio of the power received from the target to the noise power. The basic radar range equation is shown in Equation 3.

$$SNR = \frac{{P}_{1} {G}_{1} {G}_{1} {λ}^{2} σ n}{{( 4 π )}^{3} {kT}_{0} {BFL}_{S} {L}_{Scan} {R}^{4}} \qquad ( 3 )$$

$$Where for Equation ( 3 )$$

$$\begin{matrix}SNR = Signal - to - Noise Ratio & k = Boltzmann ’ s constant ( m 2 kgs - 2 K - 1 ) \\ Pt = Peak Transmit Power ( Wyatts ) & T 0 = System Noise Temperature ( 290 K ) \\ Gt = Transmitter Antenna Gain & B = Noise Bandwidth ( Hz ) \\ Gr = Receiver Antenna Gain & F = Noise Factor \\ λ = transmitted signal center wavelength ( m ) & Ls = System Losses \\ σ = target radar - cross section ( m 2 ) & Lscan = Array Scan Losses \\ n = number of pulses coherently integrated & R = Target Range ( meters )\end{matrix}$$

The terms in Equation (1) can be grouped differently as shown in Equation (4).

$$SNR = [ \frac{{P}_{t} {G}_{t} {G}_{r} {λ}^{2}}{{( 4 π )}^{3} {kT}_{0} {BFL}_{S}} ] [ \frac{σ n}{{L}_{Scan} {R}^{4}} ] \qquad ( 4 )$$

The terms in the right bracket are dependent on the target RCS and geometry relative to the radar. The terms in the left bracket are internal to the radar and remain unchanged for a given waveform and center frequency. These radar specific terms are referred to as Loop Gain (ψ) and the radar range equation can be rewritten as shown in Equation (5).

$$SNR = ψ [ \frac{σ n}{{L}_{Scan} {R}^{4}} ] \qquad ( 5 )$$

For a given radar track, the radar measures SNR and range, and the number of pulses is specified by the radar. The scan loss is a function of the scan angle which is measured by the radar. If the terms measured and/or specified by the radar are moved to the right side of the equation and the unknowns are moved to the left-hand side, the Radar Range Equation can be shown in a different form shown in Equation (6). Then, solving for the number of pulses required in the dwell yields Equation (7).

$$n = \frac{SNR \cdot {L}_{Scan} \cdot {R}^{4}}{σ \cdot ψ} \qquad ( 6 )$$

For a DS radar, coherent integration is required, and the time required to perform coherent dwells and process the data in order to achieve sufficient SNR for detection. The time required to transmit and receive n pulses is equal to Equation (7), i.e. radar dwell time.

$$\begin{matrix}{t}_{Dwell} = n \cdot PRI = ⌈ \frac{SNR \cdot {L}_{Scan} \cdot {R}^{4}}{σ \cdot ψ} ⌉ \cdot PRI \\ Where : \begin{matrix}{t}_{Dwell} = time required for a coherent dwell ( sec ) \\ PRI = Pulse Repetition Interval ( sec )\end{matrix}\end{matrix} \qquad ( 7 )$$

The ceil function is used in Equation (7) because the number of pulses must be an integer and the computation of n is defined as the “minimum number of pulses for a given SNR”. Therefore, t_{Dwell} is the time required to collect the required coherent data for a single radar measurement. There is time required to process the data, perform detection and schedule the next dwell. This time is added to Equation (7) to compute the total time for a single radar measurement. This is shown in Equation (8).

$$\begin{matrix}{t}_{Measure} = {t}_{Dwell} + {t}_{Process} = ⌈ \frac{SNR \cdot {L}_{Scan} \cdot {R}^{4}}{σ \cdot ψ} ⌉ \cdot PRI + {t}_{Process} \\ Where : \begin{matrix}{t}_{Measure} = time required to performance a single coherent radar measurement ( sec ) \\ {t}_{Process} = time required for signal and detection processing of a coherent dwell ( sec ) ( sec )\end{matrix}\end{matrix} \qquad ( 8 )$$

Next, the radar search function is performed. Fundamentally, the time required to perform radar search (t_{acquisition}) is the product of time required to process a single radar measurement (t_{Measure}) and the number of search dwells (measurements) required to acquire (also referred to herein as “track”) the satellite. For a given search volume, the radar can search the area using a number of dwells based on search volume, beam packing (how the beams are spaced), probability of detection and probability of false alarm.

The most basic model for the angular acquisition search volume is to divide the search extent in each dimension by the 3 dB beamwidth in the corresponding dimension. The equation for the number of angular search positions is shown in Equation (9).

$$\begin{matrix}{n}_{Angular} = ⌈ \frac{Δ U}{δ u} ⌉ ⌈ \frac{Δ V}{δ v} ⌉ \\ Where : \begin{matrix}{n}_{Angular} = total number of required beans to cover angular area \\ δ u = 3 dB beamwidth in u dimension ( sine space ) \\ δ v = 3 dB beamwidth in v to be searched ( sine space ) \\ Δ U = Angular Extent in U to be searched ( sine space ) \\ Δ V = Angular Extent in V to be searched ( sine space )\end{matrix}\end{matrix} \qquad ( 9 )$$

The ceil functions are included to ensure an integer number of beam positions to cover the angular search area. The angular search area is shown in FIG. 9. The search beam pattern comprises Ou 3 dB bandwidth in the u dimension 904, δv 3 dB beamwidth in the v dimension 908, ΔU the angular extent in U to be searched, and ΔV angular extent in V to be searched.

Similarly, the number of dwells at each angular beam position is the ratio of the required search range extent divided by the width of an individual radar receive window. Therefore, if a single receive window is smaller than the required range search extent, the entire angular search volume will be repeated and stacked (in range) to cover the required search volume. As an example, the four-beam pattern is stacked to cover a longer range extent in FIG. 10. The beam pattern in FIG. 10 comprises a δR receive window width, and a stacked angular search volume 1008.

Therefore, the total number of beams required for the acquisition search function is the number of angular beam positions multiplied by the total number of required range stacked receive windows. To adjust for the potential overlap or packing factor in each dimension, an efficiency term is included. The final equation is shown in Equation (10).

$$\begin{matrix}{n}_{SerchDwells} = \{ {e}_{volume} \cdot ⌈ \frac{Δ R}{δ R} ⌉ \cdot ( ⌈ \frac{Δ u}{δ U} ⌉ ⌈ \frac{Δ v}{δ V} ⌉ ) \} \\ \begin{matrix}{n}_{SerchDwells} = total number of required dwells to cover search volume \\ δ R = Receive Window Width ( Meters ) \\ {e}_{volume} = Search Efficiency \\ Δ R = Search Range Extent ( Meters )\end{matrix}\end{matrix} \qquad ( 10 )$$

The total time to complete search of the entire search volume is the product of the time per dwell and the number of dwells. However, the model does not yet account for probability of detection or probability of false alarm.

The probability of search detection (P_{d}) is the probability that the radar will correctly conclude a target is present in a dwell. Failure to detect the presence of a target will result in additional dwells being necessary to find the target in a search pattern. For this value model, the search pattern does not overlap in angles or range. Therefore, if the target is not detected in the dwell in which it is present, it will result in the entire search pattern to be repeated. Therefore, the number of scans required until the target is detected follows a Geometric Distribution, with a mean equal to the inverse of the P_{d}. Therefore, the expected search time to detect the target is the expected number of scans multiplied by the time per scan, shown in Equation (11).

$$\begin{matrix}E [ {n}_{SearchScans} ] = \frac{1}{{P}_{d}} \\ Where : {n}_{SearchScans} = the average number of scans required to detect target\end{matrix} \qquad ( 11 )$$

The total acquisition time is therefore shown in Equation (12)

$${t}_{acquisition} = E [ {n}_{SearchScans} ] \times {n}_{SearchDwells} \times {t}_{Measure} \qquad ( 12 )$$

Plugging in Equations 8, 10, and 11 into Equation 12 yields Equation (13).

$${t}_{acquisition} = \frac{\{ {e}_{volume} \cdot ⌈ \frac{Δ R}{δ R} ⌉ \cdot ( ⌈ \frac{Δ u}{δ U} ⌉ ⌈ \frac{Δ v}{δ V} ⌉ ) \} \{ ⌈ \frac{SBR \cdot {L}_{Scan} \cdot {R}^{4}}{σ \cdot ψ} ⌉ \cdot PRI + {t}_{process} \}}{{P}_{d}} \qquad ( 13 )$$

Next, there must be a radar confirmation function. After the radar determines that a target is present, it schedules a confirmation dwell to determine with high probability that the detection was indeed a target and not a false alarm. This is because the probability of a false detection in search and confirmation is the product of the two false alarm probabilities.

If successful, confirmation time is the time required to perform a single dwell, given in Equation (8). However, there are two conditions concerning the confirmation dwell that can impact the value model. The first is the results of the confirmation dwell concluding that no target was present when the target was correctly detected in search. The second is the additional confirmation dwells required due to search false alarms.

Failed confirmations impact the value model similarly to failed search detections. In fact, failed confirmations have the exact same effect on the acquisition time because a failed confirmation results in reverting back to search mode and resuming the acquisition scan. The overall probability of detection is therefore the combined probability of detection is search and probability of detection is track. This is shown in Equation (14).

$$\begin{matrix}\begin{matrix}{P}_{d} = P ( confirmation \vert search detection ) \\ = {P}_{searchDetection} {P}_{confirmationDetection}\end{matrix} \\ Where : \begin{matrix}{P}_{searchDetection} = Probability of Search Detection \\ {P}_{confirmationDetection} = Probability of Search Detection\end{matrix}\end{matrix} \qquad ( 14 )$$

Plugging Equation (14) into Equation (13) yields Equation (15).

$${t}_{acquizition} = \frac{\{ {e}_{volume} \cdot ⌈ \frac{Δ R}{δ R} ⌉ \cdot ( ⌈ \frac{Δ u}{δ U} ⌉ ⌈ \frac{Δ v}{δ V} ⌉ ) \} \{ ⌈ \frac{SBR \cdot {L}_{Scan} \cdot {R}^{4}}{σ \cdot ψ} ⌉ \cdot PRI + {t}_{process} \}}{{P}_{searchDetection} {P}_{confirmationDetection}} \qquad ( 15 )$$

Moving forward, search false alarms during the acquisition scan lead to additional time in the value model due to the subsequent confirmation dwell perfumed to determine the detection was a false alarm. The radar will initiate a confirmation dwell in response to a false search detection. For this model, it is assumed the probability of false alarm for the confirmation dwell is zero. The false alarm probability of the confirmation pulse is often very low (less than 10⁻⁶) meaning that this assumption has little effect on the value model.

The expected number of confirmation pulses required is the number of confirmation pulse due to false search detections plus the single confirmation pulse corresponding to the correct target detection. This is shown in Equation (16).

$$\begin{matrix}E [ {n}_{confirmationDwells} ] = 1 + {P}_{searchFA} E [ {n}_{SearchScans} ] {n}_{SearchDwellz} \\ Where : \begin{matrix}E [ {n}_{confirmationDwells} ] = expected number of confirmation dwells \\ {P}_{searchFA} = Probability of false alarm in search\end{matrix}\end{matrix} \qquad ( 16 )$$

Next, the total time required for the confirmation mode in the expected number of confirmation dwells computed in Equation (16) multiplied by the time required for each dwell, shown in Equation (8). The result is shown in Equation (17).

$$\begin{matrix}{t}_{verification} = E [ {n}_{confirmationDwells} ] \cdot {t}_{Measure} \\ = ( 1 + {P}_{searchFA} E [ {n}_{SearchScans} ] {n}_{SearchDwells )} \{ ⌈ \frac{SNR \cdot {L}_{Scan} \cdot {R}^{4}}{σ \cdot ψ} ⌉ \cdot PRI \\ + {t}_{Process} \}\end{matrix} \qquad ( 17 )$$

Then, after the radar has detected and verified the target, the radar initiates a sequence of track pulses in order to collect sufficient data to generate the required number of Obs. Therefore the basic form of the track time is shown in Equation (18).

$$\begin{matrix}{t}_{track} = {n}_{abs} \cdot {n}_{dwellsPerOb} \cdot {t}_{measure} \\ Where : \begin{matrix}{n}_{obs} = number of Obs requested by JSpOC \\ {n}_{dwellsPerOb} = The number of radar dwells required to generate an \\ Ob\end{matrix}\end{matrix} \qquad ( 18 )$$

The Obs are required to be of sufficient accuracy for the required orbital updates at the C2 node. Therefore, the number of radar dwells required to generate an Observation is a function of the measurement precision (sigma) for each dwell and the required precision of the Observation. The precision of a single radar measurement is related to the SNR of the return as shown in Equation (19).

$$\begin{matrix}{σ}_{Dwell}^{2} = {σ}_{X}^{2} + {σ}_{Y}^{2} + {σ}_{Z}^{2} ∝ \frac{1}{SNR} \\ Where : \begin{matrix}{σ}_{Dwell}^{2} = The total variance of the radar measurement \\ {σ}_{X}^{2} = The variance of the radar measurement in the x dimension \\ {σ}_{Y}^{2} = The variance of the radar measurement in the y dimension \\ {σ}_{Z}^{2} = The variance of the radar measurement in the z dimension\end{matrix}\end{matrix} \qquad ( 19 )$$

Solving for the SNR yields Equation (20).

$$SNR ∝ \frac{1}{{σ}_{Dwell}^{2}} \qquad ( 20 )$$

As the radar collects multiple measurements of the target, the precision of the smoothed measurement improves. Assuming Gaussian distributed errors, the Ob variance is related to the dwell variance by Equation (21).

$$\begin{matrix}{σ}_{Ob}^{2} = \frac{{σ}_{Dwell}^{2}}{{n}_{dwellsPerOb}} \\ Where : {σ}_{Ob}^{2} = The total variance of the radar Ob required by C 2 node\end{matrix} \qquad ( 21 )$$

Therefore, the number of dwells required per Observations is shown in Equation (22).

$${n}_{dwellsPerOb} = ⌈ \frac{{σ}_{Dwell}^{2}}{{σ}_{Ob}^{2}} ⌉ \qquad ( 22 )$$

Therefore, plugging Equation (8) and Equation (22) into Equation (18), we can create an equation for the track time required. This is shown in Equation (23).

$${t}_{track} = {n}_{obs} ⌈ \frac{{σ}_{Dwell}^{2}}{{σ}_{Ob}^{2}} ⌉ \cdot \{ ⌈ \frac{SNR \cdot {L}_{Scan} \cdot {R}^{4}}{σ \cdot ψ} ⌉ \cdot PRI + {t}_{Process} \} \qquad ( 23 )$$

The final value model can be computed by substituting Equations (15), (17) and (23) into Equation (2). This is shown in Equation (24).

$$\begin{matrix}{t}_{callection} = \frac{\{ {e}_{volume} \cdot ⌈ \frac{Δ R}{δ R} ⌉ \cdot ( ⌈ \frac{Δ u}{δ U} ⌉ ⌈ \frac{Δ v}{δ V} ⌉ ) \} \{ ⌈ \frac{SNR \cdot {L}_{Scan} \cdot {R}^{4}}{σ \cdot ψ} ⌉ \cdot PRI + {t}_{process} \}}{{P}_{searchDetection} {P}_{confirmationDetection}} \\ + ( 1 + {P}_{searchFA} E [ {n}_{SearchScans} ] {n}_{SerchDwells} ) \{ ⌈ \frac{SNR \cdot {L}_{Scan} \cdot {R}^{4}}{σ \cdot ψ} ⌉ \cdot PRI \\ + {t}_{Process} \} + {n}_{obs} ⌈ \frac{{σ}_{Dwell}^{2}}{{σ}_{Ob}^{2}} ⌉ \cdot \{ ⌈ \frac{SNR \cdot {L}_{Scan} \cdot {R}^{4}}{σ \cdot ψ} ⌉ \cdot PRI + {t}_{Process} \}\end{matrix} \qquad ( 24 )$$

### Example System Analysis

The following description relates to a non-limiting example scenario for a notional radar system design that has the nominal parameters shown in Table 1:

TABLE 1
Datum Design Parameters

| | Value | Units |
|---|---|---|
| Radar Parameters | | |
| Range Window Width | 1000 | meters |
| Range Search Extent | 5000 | meters |
| u Beamwidth | 0.02 | sines |
| u Search Extent | 0.05 | sines |
| v Beamwidth | 0.02 | sines |
| v Search Extent | 0.03 | sines |
| detection SNR | 18 | dB |
| loopgain | 280 | dB |
| PRI | 0.025 | seconds |
| Process Time | 1 | second |
| Pd (Search) | 0.9 | |
| Pd (verify) | 0.95 | |
| Pfa (Search) | 0.00001 | |
| Dwell Standard Deviation | 490 | meters |
| Scan Loss | 1 | dB |
| Target Parameters | | |
| Range (km) | 20,000 | km |
| Cross section | 1 | sq-meter |
| JSpOC Parameters | | |
| Ob Standard Deviation | 200 | meters |
| Number of Obs | 3 | |

Two proposed alternative designs are proposed. The first utilizes a different waveform that offers better radar Loop Gain at a cost of reduced dwell deviation. The parameters are shown in Table 2.

TABLE 2
Alternative 1 Design Parameters

| | Value | Units |
|---|---|---|
| Radar Parameters | | |
| Range Window Width | 1000 | meters |
| Range Search Extent | 5000 | meters |
| u Beamwidth | 0.02 | sines |
| u Search Extent | 0.05 | sines |
| v Beamwidth | 0.02 | sines |
| v Search Extent | 0.03 | sines |
| detection SNR | 18 | dB |
| loopgain | 283 | dB |
| PRI | 0.025 | seconds |
| Process Time | 1 | second |
| Pd (Search) | 0.9 | |
| Pd (verify) | 0.95 | |
| Pfa (Search) | 0.00001 | |
| Dwell Standard Deviation | 632.5 | meters |
| Scan Loss | 1 | dB |
| Target Parameters | | |
| Range (km) | 20,000 | km |
| Cross section | 1 | sq-meter |
| JSpOC Parameters | | |
| Ob Standard Deviation | 200 | meters |
| Number of Obs | 3 | |

Two proposed alternative designs are proposed. The first utilizes a different waveform that offers better radar Loop Gain at a cost of reduced dwell deviation. The parameters are shown in Table 2.

The second alternative offers faster processing time for each dwell at a cost of reduced range extent. The parameters for the second alternative are shown in Table 3.

TABLE 3
Alternative 2 Design Parameters

| | Value | Units |
|---|---|---|
| Radar Parameters | | |
| Range Window Width | 700 | meters |
| Range Search Extent | 5000 | meters |
| u Beamwidth | 0.02 | sines |
| u Search Extent | 0.05 | sines |
| v Beamwidth | 0.02 | sines |
| v Search Extent | 0.03 | sines |
| detection SNR | 18 | dB |
| loopgain | 280 | dB |
| PRI | 0.025 | seconds |
| Process Time | 0.5 | second |
| Pd (Search) | 0.9 | |
| Pd (verify) | 0.95 | |
| Pfa (Search) | 0.00001 | |
| Dwell Standard Deviation | 490 | meters |
| Scan Loss | 1 | dB |
| Target Parameters | | |
| Range (km) | 20,000 | km |
| Cross section | 1 | sq-meter |
| JSpOC Parameters | | |
| Ob Standard Deviation | 200 | meters |
| Number of Obs | 3 | |

Traditional requirements-based engineering approaches are inadequate at evaluating these alternatives. Using the derived value model, this is a straightforward exercise. The total time required computed using Equation (24) for each alternative is shown below in Table 4.

TABLE 4
Evaluation of Design Alternatives

| Alternative | Collection Time (sec) |
|---|---|
| Datum | 1015.4 |
| Alternative 1 | 665.6 |
| Alternative 2 | 1351.9 |

Design alternative 1 is the preferred design for this trade study. However, had all three alternatives met the requirements in the specification, there would have been no rigorous way to evaluate the three alternatives using traditional requirements-based engineering.

During trade studies and system design the value model can be used as an objective function in optimization problems. The optimization problems can use the design requirements as constraints and the objective function to quickly compare different design routes and their optimal values. Finding the optimal values that minimize the collection time in this value model allows the radar to send more Obs per day to JSPOC while saving time and money in the design process.

In addition to performance analysis trades, the utility metric can be combined with expected utility theory to account for uncertainty in the design alternatives.

As may be appreciated from the above discussion, a value model for Deep Space Surveillance radar has been derived as an effective tool for evaluating performance tradeoffs in the presence of uncertainty. An example system was used to evaluate three notional design alternatives in order to illustrate one of the uses of the Value Model.

As discussed in more detail below, at least one embodiment of the present disclosure provides solutions for what is termed as the Deep Space Search (DSS) problem in an SDA mission. The DSS problem is most commonly known to occur when a space object, such as a satellite, in outer space (e.g., deep space) is “new” or becomes “lost”—with new meaning that a space object is completely new to the system, such as new to the catalog 112, and with lost meaning that the space object was previously acquired but cannot be found, and is thus lost, for example, if the space object is known to have performed a maneuver that renders its information in the catalog 112 useless (e.g., the catalog 112 has irrelevant state vectors that make acquisition of the space object through the methods described with reference to FIGS. 1-10 very unlikely or impossible), or if the space object could not otherwise be acquired or tracked upon performing the methods described with reference to FIGS. 1-10. DSS is a difficult problem to solve for current Space Surveillance Networks (SSNs) because radar performance is dependent on the range to the fourth power—meaning that the power-aperture of the radar must be extremely large (costing 100M+) and/or the radar must have a combination of power aperture and coherent processing that requires a large amount of computing power, such as a supercomputer, to iterate through a large list of possible state vectors and hope for a positive match.

Example embodiments of the present disclosure propose to solve these and other problems of the related art by constraining the number of hypotheses for where the space object could be located, prioritizing the hypotheses from highest value to lowest value (e.g., based on an expected utility approach), and then optimizing sensor tasking of the search pattern based on each sensor's 140 availability and value model as generated based on the prioritized hypotheses. This approach significantly reduces the processing resources and/or radar capabilities required to successfully locate or relocate a lost or new space object compare to related art systems.

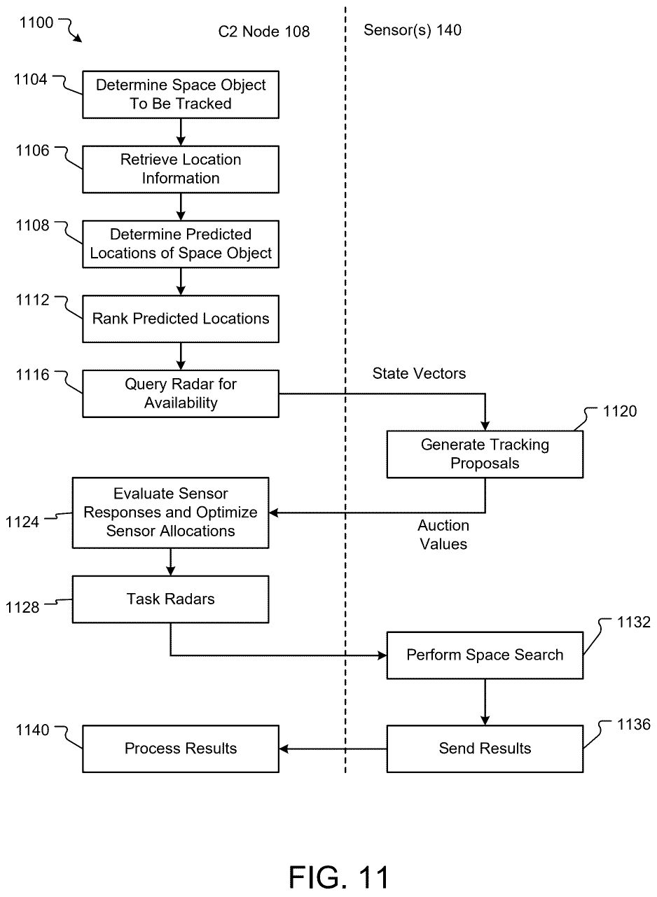

As discussed in more detail below with reference to FIG. 11, at least one feature of the present disclosure is to make the DSS multi-hypothesis search mathematically tractable by constraining the number of hypotheses. If available or assuming the space object was previously known to the system 100, e.g., as a satellite, at least the following general information is useful for reducing the uncertainties associated with DSS: 1) the last time the space object was observed to constrain its possible maneuver time to between the last observation time and the current tasking time; 2) a list of predicted location possibilities for the space object and their relative value/priority; and 3) the orbital element set ELSET for the pre-maneuvered space object. With some or all of this information, transfer orbit predictions can be created using a fuel cost metric which estimates the fuel needed to move from one orbit to another orbit and/or a transfer time metric which estimates an amount of time for the space object to move from one orbit to another orbit since these two items are likely to control how the space object is maneuvered. The transfer orbit predictions may be used to generate transfer orbit state vectors which can be fed to each sensor 140 to phase compensate radar dwells and achieve the necessary coherent integration gain for successfully acquiring the new or lost space object.

In simpler terms, the present disclosure proposes to solve the DSS problem by using information the system 100 already has or can retrieve to reduce the list of possible locations for a lost space object, such as by considering the space object's last known location and trajectory and time of last known location and identifying other space objects of interest in proximity to the last known location-some surrounding space objects may be of higher value to the system than others, and thus, the reduced list of possible locations may lean toward including higher value space objects instead of lower value space objects. This list of possible locations may be used to estimate possible orbits for the space object which are passed to the sensors 140 for running their value models which inform on how “expensive” it is to collect observation data for each possible orbit. Each possible location for the space object may be used to determine which sensors 140 have a field of view that overlaps with at least part of an orbit that includes the location, and then each possible location of the space object is prioritized according to a utility metric which takes into account a probability of the space object being found by a sensor 140 and the worth or importance of the space object relative to other space objects. The description of FIG. 11 explains these and other features in more detail below.

FIG. 11 depicts a flowchart of a method 1100 for operating an SDASN, such as that shown in FIG. 1. As shown by the vertical dashed line, the method 1100 may be performed by C2 node 108 and/or one or more sensors 140 as part of a process to newly track (or newly acquire) or retrack (or reacquire) a space object. Although the method 1100 is described with reference to a single space object, the method 100 may be carried out simultaneously or in sequence for multiple space objects. At a high level, the method involves acquiring or re-acquiring a space object with a single sensor 140 or a cooperative network of sensors 140 by constraining the search problem to a set of likely trajectories or positions for the space object based on a fastest route and/or minimum fuel cost to a set of predicted locations (e.g., orbit locations); prioritizing the likely trajectories or positions based on the space object's last observation time and/or relative importance or relative worth of the predicted trajectories or positions (referred to as Subjective Expected Utility); querying the sensor network for fulfilling search tasking using a value driven approach (e.g., using the value model from above); and optimizing the sensor tasking based on sensor responses to the querying. This combination of features provides an extremely efficient method for a radar or network of radars (or other sensor(s) 140) to perform DSS.

The method 1100 begins with step 1104 which includes determining a space object to be tracked during a tracking cycle, where the tracking cycle has the same or similar definition already provided herein as a period of time during which the sensors 140 are scheduled to attempt to locate the space object. In some examples, step 1104 includes determining that the space object is new, as in new to the catalog 112 as an uncatalogued object, and thus, identified in step 1104 as an object that needs to be acquired. In other examples, step 1104 may include determining that the space object is lost, as in the space object was previously acquired and in the catalog 112 but cannot be found due to state vectors being too out of date and/or because the space object could not be acquired or tracked. For instance, step 1104 includes receiving an indication that a previous tracking cycle, such as one carried out according to the methods of FIGS. 1-10, failed to successfully track one or more space objects, and then selecting the space object from the one or more space objects. Selecting the space object from the one or more space objects may include determining that tracking the space object during the present tracking cycle has a higher utility or importance than tracking others of the one or more space objects during the present tracking cycle. In this way, the space objected determined or selected in step 1104 may have priority over other space objects which are candidates for the method 1100, which may be due to the space object being of higher subjected utility than the other space objects because of the space object's purpose, location, proximity to other space assets, threat level, and/or the like.

In another example, step 1104 includes determining that the space object has performed a maneuver to change orbits at or after a previous point in time which corresponds to a time at which the space object was last observed and/or its ELSETs updated. That is, step 1104 may detect that the space object performed a maneuver causing the object to become lost, such as if the space object is a satellite or other self-propelled object which has been caused to intentionally or unintentionally change its orbit. In this case, the detected maneuver may have been so severe that catalog 112 now contains irrelevant state vectors that make acquisition of the space object through the methods described with reference to FIGS. 1-10 very unlikely or impossible. The maneuver of the space object may be detected by way of performing the methods described in FIGS. 1-10 and/or by way of another source, such as by receiving a notification from an external source (e.g., a government agency, operator of a satellite, etc.) that the space object has changed course and/or by way of processing of intelligence data from an external source which indicates that the space object has maneuvered away from its current orbit.

Step 1106 includes retrieving location information indicative of a known location or maneuver of the space object at a previous point in time. The location information may comprise at least part of the ELSET of the space object at the previous point in time mentioned in step 1104. For example, the location information includes state vectors of the space object at the previous point in time and/or information about the actual or estimated position or orbit of the space object from an external source such as that described above in step 1104. In some examples, the location information in step 1106 is provided by other space objects, such as satellites designed to communicate with or track the space object at hand.

Step 1106 may additionally retrieve information not related to the location or last known maneuver of the space object, such as an identifier of the space object to distinguish the space object from other space objects (e.g., satellite name), dimensions of the space object, known uses of the space object (e.g., spy satellite vs. weather satellite vs. media satellite vs. GPS satellite), proximity of the space object to an asset of interest, threat potential of the space object (the space object is generally threatening, such as an adversarial or high priority satellite, or a threat to damage another space object), other parameters of the space object that are relevant to assisting with acquiring the satellite in the method 1100, or any combination thereof.

Step 1108 includes determining or generating predicted locations of the space object for at least part of the tracking cycle based on the location information (and, in some cases, information not related to location or maneuver) and an amount of time elapsed from the previous point in time. In some examples, generating predicted locations of the space object includes generating transfer orbit predictions, which may correspond to predictions of the space object's orbit following an event, such as the above-mentioned maneuver which has moved the space object from one orbit to another orbit. Each predicted location may have a corresponding predicted transfer orbit with the predicted location corresponding to a position within a particular transfer orbit. Thus, there may be multiple predicted locations of the space object for a single predicted transfer orbit. Since the location information in step 1106 may include ELSET information at the previous point in time, the transfer orbit predictions may also be based on an ELSET of the space object at the previous point in time. The state vector and/or ELSET information at the previous point in time and the amount of time elapsed from the previous point in time may be used to predict how far the space object has traveled in a given direction using basic distance principles (e.g., distance=velocity·time or other distance principles relevant to outer space). At this stage, step 1108 has produced a list of possible locations and/or orbits of the space object, some of which can be eliminated by considering fuel cost and/or transfer time if the space object is subject to such considerations.

In some examples, then, step 1108 alternatively or additionally includes generating the predicted locations of the space object based on fuel cost, transfer time, or both. As may be appreciated, fuel is an important and limited resource of a self-propelled space object, such as satellite, and thus, the list of possible location and/or orbit predictions may be further reduced based on how much fuel the space object is estimated to consume to arrive at each possible location along each possible orbit. For example, those possible locations and/or orbits which can be reached with minimum fuel costs or less than a threshold amount of fuel may be part of the final list of predictions while possible locations and/or orbits which would require more than the threshold amount of fuel are eliminated from the final list of predictions. Similar to fuel considerations, transfer time, defined as the amount of time taken for the space object to transfer from its current location or orbit to a possible predicted location or orbit, may also be taken into account since time may be another important and finite resource for self-propelled space objects. For example, only those possible locations and/or orbits which can be reached in a minimum amount of time or less than a threshold amount of time may be part of the final list of predictions while possible locations and/or orbits which would require more than the threshold amount of time are eliminated from the final list of predictions. At the conclusion of step 1108, the method has obtained a list of predicted locations and/or orbits for the space object which is then ranked or prioritized according to step 1112.

Step 1112 includes ranking the predicted locations and/or orbits based on utilities associated with the predicted locations and/or orbits. In some examples, the utilities associated with the predicted locations are expected utilities (e.g., subjective expected utilities), where each utility is indicative of a relative worth (e.g., expected worth) of searching for the space object at a corresponding predicted location. As may be appreciated, predicted locations with higher expected utility values are ranked higher than predicted locations with lower expected utility values. In some examples, ranking the predicted locations is further based on probabilities of the one or more sensors 140 successfully acquiring or tracking the space object during the tracking cycle. Such probabilities may be determined in the same or similar manner as the probabilities describe with reference to the believability metric described with reference to FIGS. 1-10. In some examples, each predicted location's ranking may be obtained based on the utility for the corresponding predicted orbit and the probability of successfully acquiring the space object at the predicted location. For example, each predicted location of the space object may have a corresponding utility defined as, U_Positionᵢ, which is equal to the product of a probability Pᵢ of the space object being at the location multiplied by the utility of a corresponding orbit U_Orbitⱼ, expressed as:

U_Positionᵢ=Pᵢ·U_Orbitⱼ

The utility of each predicted orbit U_Orbitⱼ may vary according to the aforementioned transfer time and/or fuel costs in addition to the non-location related considerations listed in step 1106. For example, a predicted orbit may have a higher utility if the predicted orbit suggests the space object may collide with another space object, pass over or by an area of interest, and/or the like.

In some examples, step 1112 additionally or alternatively prioritizes beam regions of each sensor 140 in the same or similar manner as ranking predicted locations. For example, each radar beam region, defined as a region in space in which the radar can detect a space object based on the radar's current position, may have a utility associated with its position, U_Positionᵢ, and be ranked according to that utility defined as a product of a probability Pᵢ of the space object being within the beam region and an expected utility of the predicted orbit U_Orbitⱼ, with each Pᵢ and U_Orbitⱼ term being determined in the same or similar manner as discussed above. Prioritizing beam regions of the sensor(s) 140 in step 1112 may be considered as more precise and, in some cases, more preferrable than prioritizing predicted locations of the space object in step 1112 because the space object may be anywhere on the continuum of a predicted orbit whereas a beam region of a radar is discrete and is confined to a width of the beam for the radar, and thus, overlap of the beam region with a predicted orbit of space object may be tuned according to the probability Pᵢ.

In any event, step 1112 may produce a ranked list of prediction locations and/or beam positions with each predicted location and/or beam position placed into one of a number of categories (e.g., five categories) arranged from highest priority to lowest priority.

The result of step 1112 is used to query one or more sensors 140, for example, by performing step 1116 to send, to one or more sensors 140, a request to track the space object based on the ranked predicted locations (or the ranked beam regions). The one or more sensors 140 may be queried in the same or similar manner as that described above with reference to step 320 in FIG. 3 but instead of sending ranked space objects to sensor 140, step 1112 sends ranked predicted locations and/or ranked predicted beam regions to sensors 140.

Step 1120 includes generating, by the sensors 140 which received the request from step 1116, respective tracking proposals, which may include each sensor 140 calculating its value model and then planning search patterns for the space object based on the calculated value model in the same or similar manner as that described with reference to FIG. 3. That is, as described above with reference to steps 320 and 324 and methods 700 and 800, each of the one or more sensors 140 determines a corresponding amount of time that may be required to successfully acquire the space object based on a common value model. For example, each sensor 140 that received the request in step 1112 calculates its value model (e.g., the value model from equation 24) and sends the result back to the C2 node 108 in a tracking proposal, which may have the same or similar characteristics as the tracking proposal discussed with reference to FIGS. 1-10 except that the tracking proposal for the method 1100 is tailored for attempting to acquire a space object whose location is more uncertain than in the methods of FIGS. 1-10. The results of step 1112 may be used by the C2 node 108 to “auction off” the space object which needs to be acquired or reacquired to a subset of the sensors 140 that received the request in step 1112.

Thus, step 1124 includes the C2 node 108 receiving, from each of the one or more sensors 140, a reply comprising the tracking proposal for tracking the space object during the tracking cycle, and then evaluating the tracking proposal from each of the one or more sensors 140. The evaluation may be performed in the same or similar manner as that describe with reference to step 324 in FIG. 3 and any related sub steps of step 324 described above. For example, the C2 node 108 may apply one or more sensor-specific performance metrics, such as the believability metric, the accuracy metric, and/or the tasking response metric to the tracking proposals of each sensor 140 and then generate a sensor tasking plan based on the evaluated tracking proposals. The sensor tasking plan may have the same characteristics as the sensor tasking plan described with reference to FIGS. 1-10 and be generated based on a greedy algorithm or based on integer programming.

Step 1128 includes tasking the one or more sensors in accordance with the sensor tasking plan in the same or similar manner as described with reference to FIG. 3. In step 1132, the sensors 140 perform the space search according to the sensor tasking plan sent from the C2 node 108. In step 1136, the sensors 140 send their results as observation data to the C2 node 108, where, in step 1140, the C2 node receives the observation data for the space object from the sensors 140, processes the observation data to identify the space object and corresponding location information, and, if the space object is successfully identified, adds the identified space object and the corresponding location information to the catalog 112 of space objects.

Although not explicitly illustrated, after step 1140, the method 1100 may further include steps similar to or the same as steps 220 and 224 to evaluate performance of the one or more sensors based on the observation data, and update the believability metric of the one or more sensors, the accuracy metric of the one or more sensors, or both based on the evaluated performance.

As noted above, the present disclosure encompasses methods with fewer or more than all of the steps identified in the above-describe figures and their corresponding descriptions). The present disclosure also encompasses methods that comprise one or more steps from one method described herein, and one or more steps from another method described herein.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
at least one processor; and
memory comprising instructions, that when executed by the processor, cause the processor to:
determine a space object to be tracked during a tracking cycle;
retrieve location information indicative of a known location of the space object at a previous point in time;
generate predicted locations of the space object for at least part of the tracking cycle based on the location information and an amount of time elapsed from the previous point in time;
rank the predicted locations based on utilities associated with the predicted locations;
send, to one or more sensors, a request to track the space object based on the ranked predicted locations;
receive, from each of the one or more sensors, a reply comprising a tracking proposal for tracking the space object during the tracking cycle;
evaluate the tracking proposal from each of the one or more sensors; and
generate a sensor tasking plan based on the evaluated tracking proposals.

2. The system of claim 1, wherein determining that the space object is to be tracked comprises:
receiving an indication that a previous tracking cycle failed to track one or more space objects; and
selecting the space object from the one or more space objects.

3. The system of claim 2, wherein selecting the space object from the one or more space objects comprises determining that tracking the space object during the tracking cycle has a higher utility than tracking others of the one or more space objects during the tracking cycle.

4. The system of claim 1, wherein determining that the space object is to be tracked comprises determining that the space object has performed a maneuver to change orbits at or after the previous point in time.

5. The system of claim 4, wherein generating the predicted locations of the space object comprises generating transfer orbit predictions for the space object based on fuel cost, transfer time, or both.

6. The system of claim 5, wherein the transfer orbit predictions are based on an orbital element set (ELSET) of the space object at the previous point in time.

7. The system of claim 1, wherein the location information comprises at least part of an orbital element set (ELSET) of the space object at the previous point in time.

8. The system of claim 1, wherein the utilities associated with the predicted locations are expected utilities.

9. The system of claim 8, wherein each utility is indicative of a relative worth of searching for the space object at a corresponding predicted location.

10. The system of claim 8, wherein predicted locations with higher expected utility values are ranked higher than predicted locations with lower expected utility values.

11. The system of claim 1, wherein ranking the predicted locations based on the utilities associated with the predicted locations is further based on probabilities of the one or more sensors tracking the space object during the tracking cycle.

12. The system of claim 11, wherein each predicted location's ranking is obtained by multiplying the utility for that predicted location by the probability for that predicted location.

13. The system of claim 1, wherein the tracking proposal for each sensor corresponds to an amount of time taken for the sensor to track the space object.

14. The system of claim 13, further comprising:
the one or more sensors, wherein each of the one or more sensors determines a corresponding amount of time taken to track the space object based on a common value model.

15. The system of claim 1, wherein the memory includes instructions, that when executed by the processor, cause the processor to:
task the one or more sensors in accordance with the sensor tasking plan.

16. The system of claim 10, wherein the memory includes instructions, that when executed by the processor, cause the processor to:
receive observation data for the space object from the one or more sensors;
process the observation data to identify the space object and corresponding location information; and
add the identified space object and the corresponding location information to a catalog of space objects.

17. The system of claim 16, wherein the memory includes instructions, that when executed by the processor, cause the processor to:
evaluate performance of the one or more sensors based on the observation data; and
update a believability metric of the one or more sensors, an accuracy metric of the one or more sensors, or both based on the evaluated performance.

18. A device, comprising:
at least one processor; and
memory comprising instructions, that when executed by the processor, cause the processor to:
determine a space object to be tracked during a tracking cycle;
retrieve location information indicative of a known location of the space object at a previous point in time;
generate predicted locations of the space object for at least part of the tracking cycle based on the location information and an amount of time elapsed from the previous point in time;
rank the predicted locations based on utilities associated with the predicted locations;
send, to one or more sensors, a request to track the space object based on the ranked predicted locations;
receive, from each of the one or more sensors, a reply comprising a tracking proposal for tracking the space object during the tracking cycle;
evaluate the tracking proposal from each of the one or more sensors; and
generate a sensor tasking plan based on the evaluated tracking proposals.

19. The system of claim 18, wherein determining that the space object is to be tracked comprises determining that the space object has performed a maneuver to change orbits at or after the previous point in time, and wherein generating the predicted locations of the space object comprises generating transfer orbit predictions for the space object based on fuel cost, transfer time, or both.

20. A method, comprising:
determining a space object to be tracked during a tracking cycle;
retrieving location information indicative of a known location of the space object at a previous point in time;
generating predicted locations of the space object for at least part of the tracking cycle based on the location information and an amount of time elapsed from the previous point in time;
ranking the predicted locations based on utilities associated with the predicted locations;
sending, to one or more sensors, a request to track the space object based on the ranked predicted locations;
receiving, from each of the one or more sensors, a reply comprising a tracking proposal for tracking the space object during the tracking cycle;
evaluating the tracking proposal from each of the one or more sensors; and
generating a sensor tasking plan based on the evaluated tracking proposals.
